(19) United States
(12) Patent Application Publication
(10) Pub. No.: US 2025/0217754 A1
(43) Pub. Date: Jul. 3, 2025

(54) INFORMATION PROCESSING APPARATUS

(71) Applicant: TOYOTA JIDOSHA KABUSHIKI KAISHA, Toyota-shi (JP)

(72) Inventors: Tomiyasu ISHIKAWA, Okazaki-shi (JP); Tadashi MATSUI, Kasugai-shi (JP); Takumi KOZAWA, Nagoya-shi (JP); Yuto MOTOYAMA, Nagoya-shi (JP); Tsuyoshi OKADA, Nagoya-shi (JP); Yoshiaki MASUYA, Inazawa-shi (JP)

(73) Assignee: TOYOTA JIDOSHA KABUSHIKI KAISHA, Toyota-shi (JP)

(21) Appl. No.: 18/987,398

(22) Filed: Dec. 19, 2024

(30) Foreign Application Priority Data
Dec. 28, 2023 (JP) 2023-223107

(51) Int. Cl. G06Q 10/083; G06Q 10/1093

(52) U.S. Cl. CPC G06Q 10/083; G06Q 10/1097

(57) ABSTRACT

An information processing apparatus includes a controller configured to present, in a first time period, delivery schedule information for a vehicle before delivery at a dealer, and present, in a second time period after the first time period, delivery schedule detail information that is more detailed than the delivery schedule information.

### CROSS-REFERENCE TO RELATED APPLICATION

This application claims priority to Japanese Patent Application No. 2023-223107 filed on Dec. 28, 2023, the entire contents of which are incorporated herein by reference.

### TECHNICAL FIELD

The present disclosure relates to an information processing apparatus.

### BACKGROUND

Acquiring, from among information on the progress status of multiple vehicles before delivery stored in a progress management DB, information on the progress status of a specific vehicle corresponding to identification information and providing the acquired information to the user terminal from which the identification information has been transmitted are disclosed. For example, see Patent Literature (PTL) 1.

### CITATION LIST

### Patent Literature

PTL 1: JP 2002-297954 A

### SUMMARY

Sometimes users are stressed because the vehicles have been delivered to the dealer but have not yet been delivered to the users, wondering what the dealer is doing in the final stages. Thus, there is room for improvement with respect to technology related to the provision of information before vehicle delivery.

It would be helpful to improve technology for providing information before vehicle delivery.

An information processing apparatus according to an embodiment of the present disclosure includes a controller configured to:
present, in a first time period, delivery schedule information for a vehicle before delivery at a dealer; and
present, in a second time period after the first time period, delivery schedule detail information that is more detailed than the delivery schedule information.

According to an embodiment of the present disclosure, technology for providing information before vehicle delivery is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of an information processing apparatus;

FIG. 3 is a block diagram illustrating a schematic configuration of a terminal apparatus; and

FIG. 4 is a flowchart illustrating operations of the information processing apparatus.

### DETAILED DESCRIPTION

Hereinafter, an embodiment of the present disclosure will be described.

### Outline of Embodiment

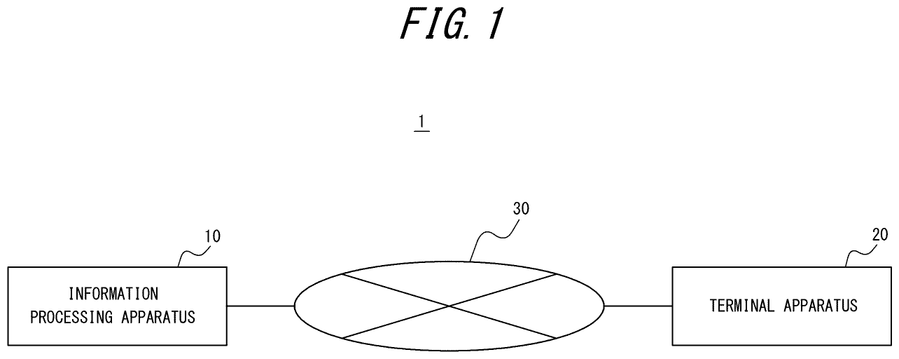

An outline and a configuration of a system 1 according to the present embodiment will be described with reference to FIG. 1.

The system 1 according to the present embodiment includes an information processing apparatus 10 and a terminal apparatus 20. The information processing apparatus 10 and the terminal apparatus 20 are communicably connected to a network 30 including, for example, a mobile communication network, the Internet, or the like.

The information processing apparatus 10 is a server apparatus installed in a data center or the like, for example. The information processing apparatus 10 is, for example, a server that belongs to a cloud computing system or other computing systems. The information processing apparatus 10 can communicate with the terminal apparatus 20 via the network 30. An example is illustrated in FIG. 1 where there is one information processing apparatus 10 included in the system 1, but is not limited to this. The system 1 may include two or more information processing apparatuses 10.

The terminal apparatus 20 is any apparatus used by a user. Users include customers waiting for delivery of their vehicles. For example, a general purpose electronic device such as a smartphone or tablet terminal, or a dedicated electronic device can be employed as the terminal apparatus 20. An example is illustrated in FIG. 1 where there is one terminal apparatus 20 included in the system 1, but is not limited to this. The system 1 may include two or more terminal apparatuses 20.

First, an outline of the present embodiment will be described, and details thereof will be described later. The information processing apparatus presents, in the first time period, delivery schedule information for the vehicle before delivery at the dealer. The information processing apparatus 10 also presents, in the second time period after the first time period, delivery schedule detail information that is more detailed than the delivery schedule information.

Thus, according to the present embodiment, the delivery schedule detail information that is more detailed than the delivery schedule information is presented in the second time period after the first time period in which the delivery schedule information has been presented. Thus, more detailed information is provided to the user in the time period closer to the time of delivery, and thus the technology for providing information before vehicle delivery is improved.

Next, configurations of the system 1 will be described in detail.

### (Configuration of Information Processing Apparatus)

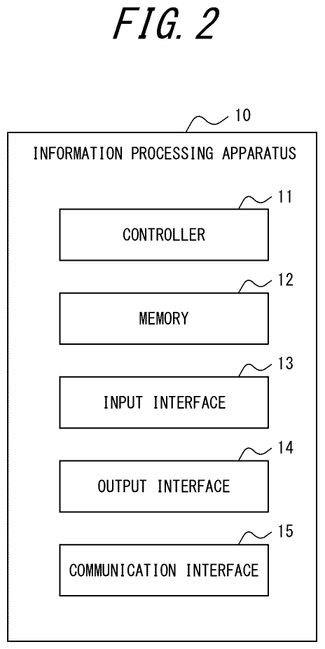

As illustrated in FIG. 2, the information processing apparatus 10 includes a controller 11, a memory 12, an input interface 13, an output interface 14, and a communication interface 15.

The controller 11 includes at least one processor, at least one dedicated circuit, or a combination thereof. The processor is a general purpose processor, such as a central processing unit (CPU) or a graphics processing unit (GPU), or a dedicated processor specialized for particular processing. The dedicated circuit is, for example, a field-programmable gate array (FPGA) or an application specific integrated circuit (ASIC). The controller 11 executes processes related to operations of the information processing apparatus 10 while controlling components of the information processing apparatus 10.

The memory 12 includes at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM) or dynamic random access memory (DRAM). The ROM is, for example, electrically erasable programmable read only memory (EEPROM). The memory 12 functions as, for example, a main memory, an auxiliary memory, or a cache memory. The memory 12 stores data to be used in the operations of the information processing apparatus 10 and data obtained by the operations of the information processing apparatus 10.

The input interface 13 includes at least one interface for input. The interface for input is, for example, a physical key, a capacitive key, a pointing device, or a touch screen integrally provided with a display. The interface for input may be, for example, an audio sensor that accepts audio input, a camera that accepts gesture input, or the like. The input interface 13 accepts an operation for inputting data to be used for the operations of the information processing apparatus 10. The input interface 13 may be connected to the information processing apparatus 10 as an external input device, instead of being included in the information processing apparatus 10. As a connection method, for example, any method such as Universal Serial Bus (USB), High-Definition Multimedia Interface (HDMI®) (HDMI is a registered trademark in Japan, other countries, or both), or Bluetooth® (Bluetooth is a registered trademark in Japan, other countries, or both) can be used.

The output interface 14 includes at least one interface for output. The interface for output is, for example, a display for outputting information in the form of a video, a speaker for outputting information in the form of audio, or the like. The display is, for example, a liquid crystal display (LCD) or an organic electro luminescent (EL) display. The output interface 14 displays and outputs data obtained by the operations of the information processing apparatus 10. The output interface 14 may be connected to the information processing apparatus 10 as an external output device, instead of being included in the information processing apparatus 10. As a connection method, any method such as USB, HDMI®, or Bluetooth® can be used.

The communication interface 15 includes at least one interface for external communication. The interface for communication may be either a wired or wireless communication interface. For wired communication, the interface for communication is, for example, a Local Area Network (LAN) interface or Universal Serial Bus (USB). For wireless communication, the interface for communication is, for example, an interface compliant with a mobile communication standard such as a Long Term Evolution (LTE), the 4th generation (4G) standard, or the 5th generation (5G) standard, or an interface compliant with a short-range wireless communication standard such as Bluetooth®. The communication interface 15 receives data to be used in the operations of the information processing apparatus 10, and transmits data obtained by the operations of the information processing apparatus 10.

The functions of the information processing apparatus 10 may be implemented by a processor, which corresponds to the information processing apparatus 10, executing a program according to the present embodiment. That is, the functions of the information processing apparatus 10 are realized by software. The program causes a computer to execute the operations of the information processing apparatus 10, thereby causing the computer to function as the information processing apparatus 10. That is, the computer executes the operations of the information processing apparatus 10 in accordance with the program to thereby function as the information processing apparatus 10.

In the present embodiment, the program can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a digital versatile disc (DVD) or a compact disc read only memory (CD-ROM) on which the program is recorded. The program may also be distributed by storing the program in a storage of an external server and transmitting the program from the external server to another computer. The program may be provided as a program product.

Some or all of the functions of the information processing apparatus 10 may be realized by a dedicated circuit corresponding to the controller 11. That is, some or all of the functions of the information processing apparatus 10 may be realized by hardware.

### (Configuration of Terminal Apparatus)

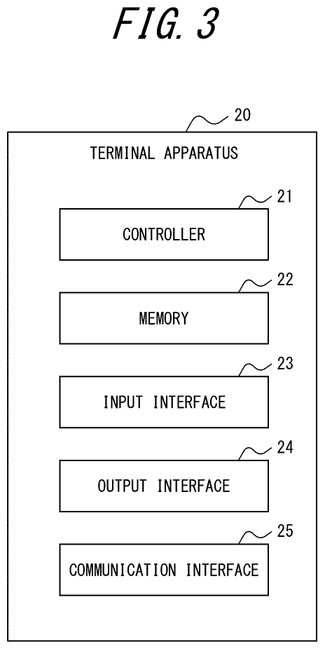

As illustrated in FIG. 3, the terminal apparatus 20 includes a controller 21, a memory 22, an input interface 23, an output interface 24, and a communication interface 25.

The controller 21 includes at least one processor, at least one dedicated circuit, or a combination thereof. The processor is a general purpose processor, such as a central processing unit (CPU) or a graphics processing unit (GPU), or a dedicated processor specialized for particular processing. The dedicated circuit is, for example, a field-programmable gate array (FPGA) or an application specific integrated circuit (ASIC). The controller 21 executes processes related to operations of the terminal apparatus 20 while controlling components of the terminal apparatus 20.

The memory 22 includes at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM) or dynamic random access memory (DRAM). The ROM is, for example, electrically erasable programmable read only memory (EEPROM). The memory 22 functions as, for example, a main memory, an auxiliary memory, or a cache memory. The memory 22 stores data to be used for the operations of the terminal apparatus 20 and data obtained by the operations of the terminal apparatus 20.

The input interface 23 includes at least one interface for input. The interface for input is, for example, a physical key, a capacitive key, a pointing device, or a touch screen integrally provided with a display. The interface for input may be, for example, an audio sensor that accepts audio input, a camera that accepts gesture input, or the like. The input interface 23 accepts an operation for inputting data to be used for the operations of the terminal apparatus 20. The input interface 23 may be connected to the terminal apparatus 20 as an external input device, instead of being included in the terminal apparatus 20. As a connection method, for example, any method such as Universal Serial Bus (USB), High-Definition Multimedia Interface (HDMI®), or Bluetooth® can be used.

The output interface 24 includes at least one interface for output. The interface for output is, for example, a display for outputting information in the form of a video, a speaker for outputting information in the form of audio, or the like. The display is, for example, a liquid crystal display (LCD) or an organic electro luminescent (EL) display. The output interface 24 displays and outputs data obtained by the operations of the terminal apparatus 20. The output interface 24 may be connected to the terminal apparatus 20 as an external output device, instead of being included in the terminal apparatus 20. As a connection method, any method such as USB, HDMI®, or Bluetooth® can be used.

The communication interface 25 includes at least one interface for external communication. The interface for communication may be either a wired or wireless communication interface. For wired communication, the interface for communication is, for example, a Local Area Network (LAN) interface or Universal Serial Bus (USB). For wireless communication, the interface for communication is, for example, an interface compliant with a mobile communication standard such as a Long Term Evolution (LTE), the 4th generation (4G) standard, or the 5th generation (5G) standard, or an interface compliant with a short-range wireless communication standard such as Bluetooth®. The communication interface 25 receives data to be used for the operations of the terminal apparatus 20, and transmits data obtained by the operations of the terminal apparatus 20.

The functions of the terminal apparatus 20 are realized by execution of a program according to the present embodiment by a processor corresponding to the terminal apparatus 20. That is, the functions of the terminal apparatus are realized by software. The program causes a computer to execute the operations of the terminal apparatus 20, thereby causing the computer to function as the terminal apparatus 20. That is, the computer executes the operations of the terminal apparatus 20 in accordance with the program to thereby function as the terminal apparatus 20.

Some or all of the functions of the terminal apparatus 20 may be realized by a dedicated circuit corresponding to the controller 21. That is, some or all of the functions of the terminal apparatus 20 may be realized by hardware.

### (Operations of Information Processing Apparatus)

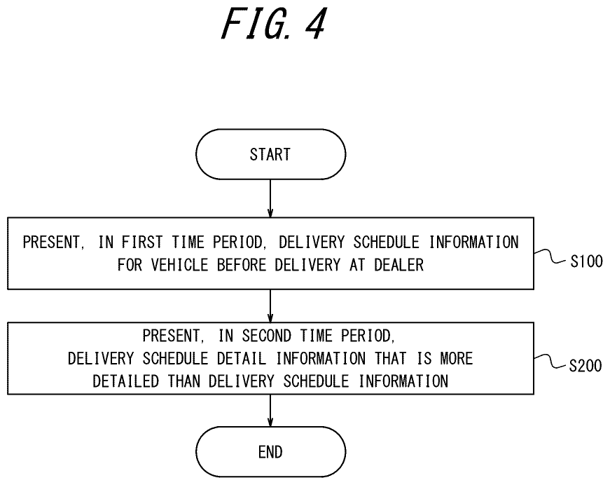

Operations of the information processing apparatus 10 according to the present embodiment will be described with reference to FIG. 4.

Step S100: The controller 11 of the information processing apparatus presents, in the first time period, the delivery schedule information for the vehicle before delivery at the dealer. The first time period is during the first predetermined period from when the vehicle is transported from the manufacturing plant to the dealer. The first predetermined period may be arbitrarily determined, for example, several months (e.g., three months) starting from the completion of transportation of the vehicle from the factory to the location of the dealer.

The delivery schedule information includes, for example, an estimate of when the vehicle will be delivered to the user. For example, the approximate information may be in six months, spring, summer, fall, winter, etc.

Any method can be employed to present the delivery schedule information for the vehicle. For example, the controller 11 may present the delivery schedule information by means of a user interface displayed and output by the output interface 24 of the terminal apparatus 20. Such a user interface may be provided by the information processing apparatus 10 or a web server, accessed by the terminal apparatus 20 via browser software. Alternatively, an application pertaining to the system 1 may be installed on the terminal apparatus 20, and the terminal apparatus 20 may provide the user interface by communicating with the information processing apparatus 10 or application server via said application, as appropriate. In this case, the terminal apparatus 20 and the information processing apparatus 10, or the terminal apparatus 20 and the web server, may perform authentication and other processes related to the user, as appropriate.

Step S200: The controller 11 presents, in the second time period, delivery schedule detail information that is more detailed than the delivery schedule information. The second time period is a time period after the first time period and during the second predetermined period prior to the scheduled delivery. The second predetermined period may be arbitrarily determined, e.g., several months (e.g., three months) prior to the scheduled delivery date.

The delivery schedule detail information includes, for example, information indicating the remaining number of days until the delivery time period. The delivery schedule detail information may also include information pertaining to the number of vehicles waiting to be delivered. In other words, the controller 11 may indicate the progress status by the number of vehicles waiting to be delivered.

Any method can be employed to present the delivery schedule detail information for the vehicle, as described above. For example, the controller 11 may present the delivery schedule detail information using a user interface displayed and output by the output interface 24 of the terminal apparatus 20.

As described above, the information processing apparatus 10 according to the present embodiment presents the delivery schedule detail information that is more detailed than the delivery schedule information in the second time period after the first time period in which the delivery schedule information has been presented. Thus, more detailed information is provided to the user in the time period closer to the time of delivery, and thus the technology for providing information before vehicle delivery is improved.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or a single component, step, or the like can be divided.

For example, in the present embodiment, a two-step presentation method in which the controller 11 presents the delivery schedule information in the first time period and presents the delivery schedule detail information in the second time period has been described, but the number of steps is not limited to this. For example, the controller 11 may present detailed information on the delivery schedule in more steps (e.g., three or more steps). In other words, the controller 11 may present more detailed information on the delivery schedule as the scheduled delivery date approaches.

For example, the controller 11 may also present a plurality of panels indicating the remaining number of days until the delivery time period based on the delivery schedule detail information. For example, the plurality of panels may consist of five rows and five columns. The controller 11 may present an image of one such panel turned over in one day. In this way, progress status until vehicle delivery can be visualized without monotony.

The controller 11 may also present an image showing the vehicle according to the remaining number of days until the delivery time period based on the delivery schedule detail information. For example, the controller 11 may initially present an unfinished image (e.g., a hand-drawn picture) and eventually present a finished image of a car travelling. The completed image may be generated by an image generation AI. For example, the completed image may be an image generated by inputting a prompt specified by the purchaser to the image generation AI. The finished image may be available as a stamp, icon, etc. for social media used by the user.

In the case where the progress status is presented in terms of the number of vehicles waiting to be delivered, the controller 11 may grant points to the user according to the remaining number of vehicles when the user accesses the application or other means. For example, if the remaining number of vehicles is a sequential number (e.g., 11, 22, 33, etc.) or a round number (e.g., 10, 20, 30, etc.), the controller 11 may grant points to the user. Recommendations, popular dealer options, and other additional purchase options may also be displayed when accessing the application.

In this system 1, the delivery schedule may be changed based on a mechanism that gives priority to a predetermined user compared to other users and allows for an earlier delivery date. For example, a user may charge for priority response services so that the delivery date of the vehicle of a user who has charged for the service will have priority over the delivery date of the vehicle of a user who has not charged for the service.

The first time period and the second time period may be determined according to the type, content, or the like of the remaining work at the dealer. For example, the first time period may be the time period when there is remaining work with uncertainties that affect the delivery time period. Remaining work with uncertainties that affect the delivery time period is, for example, the installation of optional items for which delivery dates to dealers have not yet been determined. On the other hand, the second time period may be the time period when there is no more remaining work with uncertainties affecting the delivery time period. In this way, if there are uncertainties that affect the delivery time period, an estimated delivery time period can be presented to the user, and if there are no more uncertainties, a detailed delivery time period can be presented to the user.

1. An information processing apparatus comprising a controller configured to:
present, in a first time period, delivery schedule information for a vehicle before delivery at a dealer; and
present, in a second time period after the first time period, delivery schedule detail information that is more detailed than the delivery schedule information.

2. The information processing apparatus according to claim 1, wherein
the first time period is during a first predetermined period from when the vehicle is transported from a manufacturing plant to the dealer, and
the second time period is during a second predetermined period prior to a delivery time period based on the delivery schedule information.

3. The information processing apparatus according to claim 1, wherein the controller is configured to present a plurality of panels indicating a remaining number of days until a delivery time period based on the delivery schedule detail information.

4. The information processing apparatus according to claim 1, wherein the controller is configured to present an image showing the vehicle according to a remaining number of days until a delivery time period based on the delivery schedule detail information.

5. The information processing apparatus according to claim 1, wherein the delivery schedule detail information includes information pertaining to a number of vehicles waiting to be delivered.
